(19) United States
(12) Patent Application Publication
(10) Pub. No.: US 2022/0008798 A1
(43) Pub. Date: Jan. 13, 2022

(54) A BALL STRIKING TRAINING SIMULATOR

(71) Applicant: STRIKECOSENSE LTD, Kibutz Gazit (IL)

(72) Inventors: Ori FUCHS, Kibutz Gazit (IL); Sharon SHULSHTAIN, Kibutz Gazit (IL); Yonatan WILAND, Kibutz Gazit (IL)

(21) Appl. No.: 17/293,818

(22) PCT Filed: Nov. 12, 2019
(86) PCT No.: PCT/IL2019/051234

§ 371 Date: May 13, 2021

(30) Foreign Application Priority Data
Nov. 15, 2018 (IL) 263060

(51) Int. Cl. A63B 69/00; A63B 24/00; A63B 71/06

(52) U.S. Cl. CPC A63B 69/0091; A63B 24/0062; A63B 71/0622; A63B 2102/02; A63B 2220/53; A63B 2220/833; A63B 2220/89; A63B 2220/35

(57) ABSTRACT

The present invention pertains to a ball-striking aid apparatus or simulator that includes a chassis for holding a ball and allowing rotation thereof, one or more sensors for detecting one or more ball stroke parameters and optionally a computing device being in communication with the one or more sensors and adapted to provide an input with respect to the one or more parameters.

### FIELD OF THE INVENTION

The present invention relates, in some embodiments thereof, to a ball striking training simulator that provides real time feedback concerning ball strokes training. In some embodiments, the training simulator includes a chassis for holding a ball and allowing rotation thereof and one or more sensors for monitoring one or more ball stroke parameters.

### BACKGROUND OF THE INVENTION

There are several common stroke flaws associated with tennis practicing. Many of these flaws occur in the swing or stroke of a player, due in part to improper positioning and/or movement of the wrist and/or racket.

A few training aid devices have been presented in the prior art to attempt to correct for some of these flaws. For example, various tennis devices attempting to teach proper wrist and racket positioning have been devised and are currently known. Such devices allow players to practice their strokes but provide no feedback about those strokes. Accordingly, the player cannot assess its stroke performance, monitor progress, and/or share a training course. Sensors affixed to rackets are also known, but those rackets provide inaccurate knowledge and have failed to produce accurate measurements.

It would therefore be desirable to provide a tennis training device that is operable in multiple usage modes to allow a player to easily, effectively and comfortably practice different types of tennis strokes.

### SUMMARY OF THE INVENTION

Objects of the invention are achieved by providing a simulator for practicing ball strokes. Objects of the invention are achieved by providing an interactive simulator for practicing ball strokes.

The present invention pertains to a ball striking aid apparatus or simulator that includes a chassis for holding a ball and allowing rotation thereof, one or more sensors for detecting one or more ball stroke parameters and optionally a computing device being in communication with the one or more sensors and adapted to provide an input with respect to the one or more parameters.

A first aspect of the invention relates to a ball stroke training simulator, the simulator comprising:

a ball;

a first arm connected to the ball and configured to allow rotation thereof about a pivot between the first arm and the ball; and

a second arm pivotally connected to the first arm such that the first arm is moveable about the pivot between the first and second arms.

A second aspect of the invention relates to a ball stroke training simulator, the simulator comprising:

a ball;

a first arm connected to the ball and configured to allow rotation thereof about a pivot between the first arm and the ball;

a second arm pivotally connected to the first arm such that the first arm is moveable about the pivot between the first and second arms; and

at least one sensor adapted to monitor one or more ball stroke parameters.

A third aspect of the invention relate to a ball stroke training device, the training device comprising:

a ball;

a chassis for supporting said ball and allowing rotation thereof;

one or more sensors for measuring one or more ball stroke parameters, the one or more sensors attached to the ball and/or to said chassis; and

a computing device being in communication with said one or more sensors and adapted to provide an output of said one or more parameters.

In one or more embodiments, the simulator further comprising a connector for connecting between the ball and the first arm, the connector attached to the ball via a bearing allowing rotation of the ball around its axis.

In one or more embodiments, the connector comprises an arc or a portion thereof configured to surround at least a portion of the ball.

In one or more embodiments, the connector is integrally attached to the first arm.

In one or more embodiments, the connector is at least partially resilient allowing a slight deformation thereof by a ball stroke.

In one or more embodiments, the at least one sensor is affixed to the connector, and/or the bearing.

In one or more embodiments, the sensor measures deformation of the resilient portion of the connector, thereby providing stroke force and/or stroke direction.

In one or more embodiments, the at least one sensor is affixed to the ball, the first arm, the second arm, the pivot between the first arm and the second arm or a combination thereof.

In one or more embodiments, the sensor measures the ball's spin count per unit of time, speed rotation of the ball around its axis, angle of ball stroke, ball force stroke and/or first arm rotation speed.

In one or more embodiments, the ball includes a magnet and the sensor monitors the magnetic pulses of the ball when in rotation.

In one or more embodiments, the first arm being up to 180 degrees rotatable about said pivot between the first arm and the second arm.

In one or more embodiments, the simulator further comprising a support means for providing support to said arms.

In one or more embodiments, the support means being connected to first or second arms via binding means that are configured to allow adjusting the height of the first or second arms.

In one or more embodiments, the binding means comprise plane adjusting means allowing adjusting the plane of the arm with respect to the ground.

In one or more embodiments, the simulator further comprising a computing device, wherein the computing device being in communication with said one or more sensors and adapted to provide an output of said one or more parameters.

In one or more embodiments, the computing device configured to process and analyze said ball stroke parameters.

In one or more embodiments, the simulator further comprising a display module adapted to present said output.

In one or more embodiments, the simulator further comprising a display module adapted to present said analysis.

In one or more embodiments, the display module is a screen. In one or more embodiments, the display module is an amplifier, or a speaker.

In one or more embodiments, the ball stroke output includes: stroke count, spin speed of the ball, ground speed of the ball, angle of ball stroke, force of ball stroke, and a combination thereof.

In one or more embodiments, the computing device is capable of calculating the expected theoretical ball path according to the measured parameters of the stroke. In one or more embodiments, the computing device is configured to detect whether the ball would hit within the rival's court boundaries or not. In one or more embodiments, said ball path or ball hit determination could be further communicated to the user via said display output module. In one or more embodiments, the computing device is configured to present a training schedule or lesson, is configured to present the progress of a trainee, is configured to provide a training schedule or lesson according to the trainees' capabilities or progress.

In one or more embodiments, the simulator further comprising a camera for imaging the ball strokes.

In one or more embodiments, the computing device being in communication with said one or more sensors via a wire or a wireless connection.

In one or more embodiments, the sensor is selected from a force sensor adapted to measure the stroke force, a speed sensor adapted to measure the spinning speed of the ball, and a touch sensor adapted to measure stroke angle.

In one or more embodiments, the sensor is selected from an accelerometer, potentiometer, gyroscope, a magnetic sensor, a hall-effect sensor, a strain gage, and a combination thereof.

In one or more embodiments, the chassis comprises a first arm connected to the ball such that the ball is rotatable about a pivot between the first arm and the ball.

In one or more embodiments, the chassis comprises a second arm pivotally connected to the first arm such that the first arm is moveable about the pivot between the first and second arms.

In one or more embodiments, the simulator further comprising support means for providing support to said chassis.

In one or more embodiments, the simulator further comprising a connector for connecting between the ball and the first arm, the connector attached to the ball via a bearing allowing rotation of the ball around its axis.

In one or more embodiments, the connector comprises an arc or a portion thereof configured to surround at least a portion of the ball.

In one or more embodiments, the connector is integrally attached to the first arm.

In one or more embodiments, the connector is at least partially resilient allowing at least a slight deformation of the connector by a ball stroke.

In one or more embodiments, the connector is connected to the first arm through a bearing or other mechanism that allows a multi directional movement. In one or more embodiments, the connector or bearing allows a slight movement of the ball in a similar or same direction of the stroke hit.

In one or more embodiments, said bearing is further equipped with a sensor that could measure the direction of said free movement of the ball and other parameters thereof.

In one or more embodiments, the simulator comprises at least one sensor affixed to the ball.

In one or more embodiments, the simulator comprises at least one sensor affixed to the connector and/or to the bearing.

In one or more embodiments, the sensor measures speed rotation of the ball around its axis, angle of ball stroke, ball force stroke and/or first arm rotation speed.

In one or more embodiments, the computing device configured to process and evaluate said ball stroke parameters and provide an output thereof.

In one or more embodiments, the ball stroke output includes: stroke count, spin speed of the ball, ground speed of the ball, angle of ball stroke, force of ball stroke, and a combination thereof.

In one or more embodiments, the simulator further comprising a camera for imaging the ball stroke.

In one or more embodiments, the computing device being in communication with said one or more sensors via a wire or a wireless connection.

In one or more embodiments, the sensor is selected from a force sensor adapted to measure the stroke force, a speed sensor adapted to measure the spinning speed of the ball, and a touch sensor adapted to measure stroke angle.

In one or more embodiments, the sensor includes a magnet and a counter. In one or more embodiments, the sensor is selected from an accelerometer, potentiometer, gyroscope and a combination thereof.

In one or more embodiments, the first arm, second arm and/or pivot between the arms include a spring adapted to revert position of the first arm after movement thereof in response to a ball stroke.

In one or more embodiments, the spring is selected from a compression spring, an extension spring, a torsion spring, a constant force spring, and a combination thereof.

In one or more embodiments, the spring is adjustable allowing adjusting the reversion speed of the first arm.

Unless otherwise defined, all technical or/and scientific terms used herein have the same meaning as commonly understood by one of ordinary skill in the art to which the invention pertains. Although methods and materials similar or equivalent to those described herein can be used in the practice or testing of embodiments of the invention, exemplary methods or/and materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an isometric side-top view demonstrating a portion of a device for ball stroke training that includes an arm attached to a connector that holds a ball via a bearing such that the ball is rotatable about the bearing; according to some embodiments of the invention;

FIG. 2 is a side isometric view demonstrating the device of FIG. 1, which further includes a second arm connected to the first arm in a manner allowing movement of the first arm, according to some embodiments of the invention;

FIG. 3 is a side isometric view of the device of FIGS. 1-2, wherein the second arm is connected to supporting means, such as, a tripod for supporting or holding the device, according to some embodiments of the invention;

FIGS. 4A-4C are a close up view, an isometric side view, and an isometric back view of the binding means that allow binding the herein disclosed device to a supporting means, according to some embodiments of the invention;

FIGS. 5A-5C are side isometric views of the device of the preceding figures, wherein the second arm includes binding means which allow adjusting the height and rotation of second arm, according to some embodiments of the invention.

It should be appreciated that for simplicity and clarity of illustration, elements shown in the figures have not necessarily been drawn to scale. For example, the dimensions of some of the elements are exaggerated relative to each other for clarity. Further, where considered appropriate, reference numerals have been repeated among the figures to indicate corresponding elements.

### DETAILED DESCRIPTION OF THE INVENTION

It is understood that the invention is not limited to the particular methodology, devices, items or products etc., described herein, as these may vary as the skilled artisan will recognize. It is also to be understood that the terminology used herein is used for the purpose of describing particular embodiments only and is not intended to limit the scope of the invention. The following exemplary embodiments may be described in the context of exemplary devices or methods for ease of description and understanding. However, the invention is not limited to the specifically described products and methods and may be adapted to various applications without departing from the overall scope of the invention. All ranges disclosed herein include the endpoints. The use of the term “or” shall be construed to mean “and/or” unless the specific context indicates otherwise.

The present invention pertains to an inventive apparatus or simulator for practicing ball strokes. The apparatus or simulator of the invention is particularly useful for practicing tennis but can also be applicable for practicing other sport types.

In an aspect of the invention, the simulator or device includes a chassis for holding a ball and one or more sensors for detecting one or more stroke parameters, such as the ball's speed and/or spin.

Optionally, the herein disclosed devices or simulator further include a computing device which communicates with the one or more sensors and provides an output of the one or more ball stroke parameters.

Additionally, or alternatively, the devices or simulators includes sensors which can communicate with a computing device, allowing displaying or providing an output of the ball stroke parameters. In accordance with this embodiment, the one or more sensors include a wired or a wireless communication transmitter unit allowing transmitting the ball stroke parameters to a computing device.

As used herein the term “ball stroke parameters” includes any possible information associated with ball strokes. The term includes, without limitation, ball spin speed, ball direction, ball orientation, stroke force, spin count per unit of time, ball theoretical route, and a combination thereof.

As used herein the term “computing device” may include various electronic devices which receive data, process the data, calculate results from the data, and/or present the data. By way of example only and without any limitation, the computing device may be selected from a personal computer, a desktop computer, a laptop computer, a handheld device, a cellular phone, a smartphone, virtual reality glasses, or the like. In one or more embodiments, the computing device includes a software application configured to receive data from the one or more sensors. Optionally, the software application is further configured to analyze the data and to display data via an audible module or via a display screen. In one or more embodiments, the computing device is configured to receive the data and to further transmit it to a cloud-based server which is a web-based software application to share data regarding the ball stroke parameters. In one or more embodiments, the computing device can process the parameters and display an output providing the player stroke performance evaluation. Optionally, the output provided by the computing device can be stored, shared and/or deleted after displaying thereof. The capability to share and/or store stroke history allows to monitor progress and obtaining a coach feedback. Optionally a camera may be provided separately or along with the herein disclosed device for recording the ball strokes. Optionally, the output provided by the sensors can be shared, for example, via a social media or any of the alike. Optionally, the computing device includes a software configured to create training lessons to each trainee. The training lessons may be devised according to the progress of the trainee.

Thus, utilizing one or more sensors along with a computer device as herein disclosed affords one or more of the following attributes:

Rapid or immediate display of the ball's speed and spin for each stroke.

Analyzing the one or more ball stroke parameters.

Ranking ball stroke performance.

Sharing the workouts on a social media or with a coach for obtaining an input about the ball stroke performance.

Optionally, the analyzed ball stroke parameters include building training lessons according to the progress of the trainee. Optionally, analyzing the ball stroke parameters include calculating the hit point, and/or predicting the path of the ball.

Various sensors are contemplated for measuring the various stroke parameters. The sensors may include, but are not limited to an accelerometer, a potentiometer, a gyroscope, magnetic sensor, hall-effect sensor, strain gage, and a combination thereof. In one exemplary embodiment, the sensor is a magnetic sensor indicating the ball's spin speed. In one exemplary embodiment, the sensor is a potentiometer indicating the linear velocity of the ball. In one exemplary embodiment, the sensor is a strain gauge sensor indicating the ball's direction and/or stroke force. In one exemplary embodiment, the sensor is an accelerometer indicating the ball's spin speed and linear velocity. In one exemplary embodiment, the ball includes a MEMs element indicating the ball's spin speed and linear velocity. In one exemplary embodiment, the sensor is a gyroscope indicating the ball's orientation and angular velocity. In one or more embodiments, the herein disclosed devices include at least one sensor. In one or more embodiments, the herein disclosed devices include at least two, at least three or at least four sensors.

In one or more embodiments, the chassis or simulator body or device includes a unique and inventive structure allowing training of various stroke types in various angles and heights. The chassis is therefore advantageously dynamic, adjustable, versatile and simulates various ball strokes. By way of example only and without any limitation, the various ball strokes include ground strokes and volleys, top spins, flat or slice shots.

Optionally the ball is cushioned in its interior with a material that provides a true sense of ball stroke. Such cushioning prevents deformation of the ball about its axis as a result of striking the ball. By way of example, the cushioning could be made from a material such as a foamed polyurethane, polyethylene or polystyrene or any other material or substance that suits and allows to imitate the real feel of hitting a game ball.

The chassis includes a first arm for holding a ball in a manner allowing rotation thereof. The first arm and the ball may be connected to each other via various forms, such as via a pivot or a spindle which may include one or more bearings, allowing the efficient rotation of the ball.

The chassis may further include a second arm pivotally attached to the first arm. The first and second arms are connected in a way allowing rotation or movement of the first arm with respect to the second arm. Optionally, the first and second arms are connected to each other via a connector which may be articulated, and which may include a pivot about which the first arm is moveable or can be adjusted according to the desired ball stoke practice. In an embodiment of the invention, the first arm is moveable about the pivot, up to 180 degrees with respect to second arm. The second arm may therefore be stationary with respect to first arm.

Optionally, the device or chassis include binding means allowing binding thereof to supporting means, such as a base structure (e.g., a tripod). Advantageously, the binding means may also be adjustable, allowing to customize the height of the arms as desired. For example, the user may lower and/or raise the first arm. Such dynamic configuration allows various stroke type training, such as, volleys, top spins, flat or slice strokes. Also, the dynamic moveable structure of the chassis and particularly of the first arm, allows various angles and strokes heights. Advantageously, due to the compact and mobile structure of the chassis, the player can practice ball strokes outdoor and even indoor.

In one or more embodiments, the one or more sensors may be coupled to the ball or to the herein disclosed device or chassis at various positions. By way of example only, and without any limitation, the sensor may be coupled to the ball, the first arm, the connector connecting the first arm and the ball, the connector connecting the first arm and the second arm, the first arm, the second arm, and a combination thereof. Optionally, the ball is loaded with a plurality of sensors, thereby indicating the location and angle of ball stroke. Optionally, the sensors along with the computing device are configured to analyze the one or more parameters and provide indicate the type of ball stroke (e.g., topspin or slice).

Optionally, dedicated structures (e.g., a conus) are further included along with one or more sensors and coupled to the herein disclosed devices/simulators/chassis and provide monitor measurements regarding the trainee's motions.

Optionally, the first arm, second arm and/or pivot between the arms include a return member adapted to revert position of the first arm after movement thereof in response to a ball stroke. In an exemplary embodiment, the return member is a spring. In one or more embodiments, the spring is selected from, but is not limited to a compression spring, an extension spring, a torsion spring, a constant force spring, and a combination thereof. In one or more embodiments, the spring is adjustable allowing adjusting the reversion speed of the first arm. In accordance with this embodiment, the spring can be adjusted as desired to comply with the ball stoke type and/or force, and/or speed and/or frequency.

In an exemplary embodiment, a sensor for measuring the ball rotation speed around its axis may be attached to the ball and/or to a position adjacent the ball, and/or to a connector between the first arm and the ball. In an exemplary embodiment, a sensor for measuring the hit angle and stroke force may be attached to the first arm or to a position adjacent the first arm, and/or to a connector between the first arm and the second arm. In an exemplary embodiment, a sensor for measuring stroke force and/or stroke direction may be coupled to a connector between the ball and the first arm.

Thus, the herein disclosed chassis or device as herein disclosed affords one or more of the following attributes:

Free-ball rotation structure.

Moveable arm which may be adjusted according to the desired ball stroke training type.

Height adjustable allowing training of various ages.

Mobile, allowing practicing ball strokes outdoor and indoor.

In one or more embodiments, the term “stationary” refers to any objects or subjects that are non-movable.

Thus, the present invention overcomes problems of known and currently used training apparatus that provide no feedback or indication regarding the ball stroke performance. Advantageously, the herein invention is user friendly, interactive, non-complex and customizable.

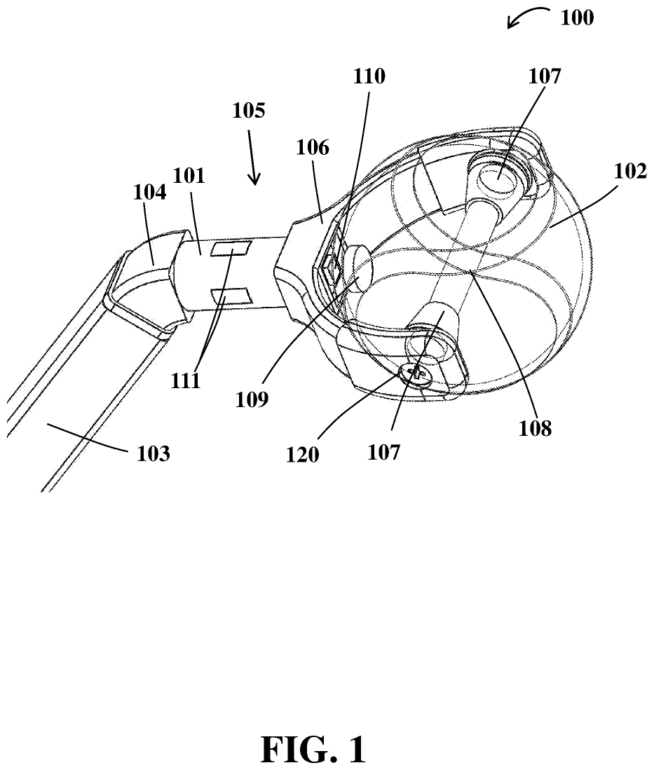

Referring now to the drawings, FIG. 1 demonstrates a close up view of a portion of a device or chassis 100 that includes a first arm 103 attached to a ball 102 via an articulated connector 105 connecting between first arm 103 and ball 102. Connector 105 includes a joint 104, a connector body 101, and an arc 106 with bearings 107. A tennis ball 102 is herein shown, but alternative ball types can also be applicable. Connector body 101 is manufactured from a resilient or a partially resilient material allowing distortion or deformation thereof as a result of ball striking. One or more sensors 111, such as strain gauges, that measures the distortion or deformation of connector body 101 by ball strokes, can be coupled onto connector 105, optionally around a periphery of connector body 101. Such deformation or distortion measurements of body 101 by sensors 111 provide stroke force and/or stroke direction.

The ball 102 is loaded onto a rod 108 spindle which optionally include one or more bearings 107. The connector 105 can attach ball 102 via one or more bearings 107. Optionally, an arc 106 extending from body 101 surrounds the ball 102 and attaches it via opposing screws 120. It is to be understood that the herein disclosed invention is not limited in scope to a connector having an arc-like form but contemplates alternative forms of connectors between first arm 103 and ball 102. For example, a half arc surrounding a portion of ball 102 which connects ball 102 via one screw 120 and spindle 108 is further applicable. The device 100 further optionally includes a sensor 110 that optionally measures (e.g., counts) magnetic pulses each time magnet 109 passes by the sensor 110. This pulses frequency can be translated to ball spin speed. That is to say, each stroke causes spinning or rotation of ball 102 about its axis or about rod 108, and sensor 110 measures the number of magnetic pulses for each such ball stroke. The magnet 109 may be affixed internally within the ball 102. For example, the magnet 109 is affixed to an internal surface of ball 102. Optionally, one or more sensors may be coupled to ball 102 for monitoring the location of the racket stroke and/or angle of stroke.

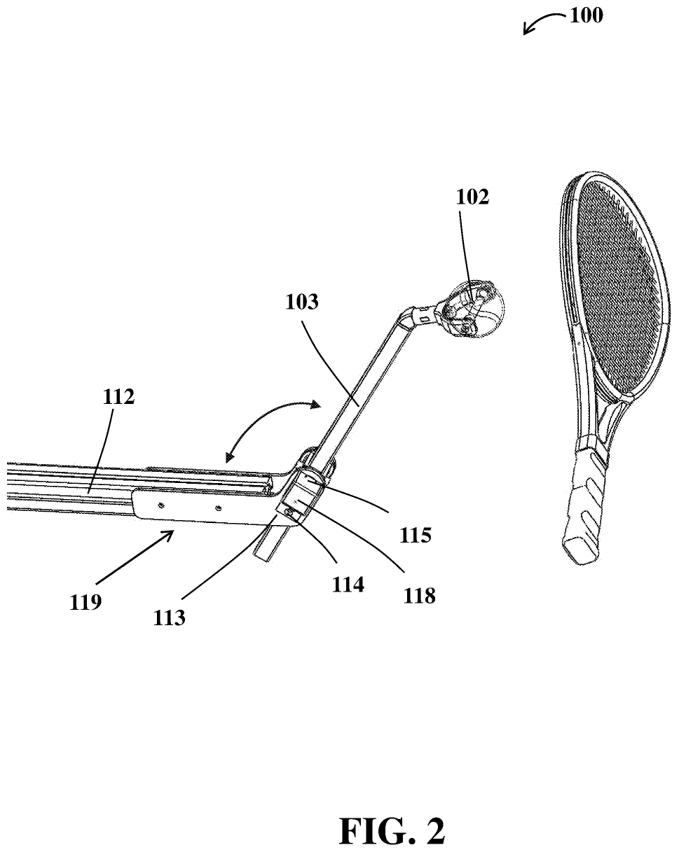

Reference is now made to FIG. 2 which demonstrates device 100 that further includes a second arm 112 connected to first arm 103 via articulated connector 119 that includes joint 113. The connection between first arm 103 and second arm 112 allows movement of the first arm 103 with respect to second arm 112. The connection between first arm 103 and second arm 112 may be via a pivot 114 allowing various ranges of movements of the first arm 103 with respect to second arm 112. For example, first arm 103 may be up to 180 deg. moveable about the pivot 114. But typically, it will be up to 150 deg. The device 100 consequently allows movement of ball 102 about its axis, and/or movement of first arm 103 with respect to second arm 112. Joint 113 may include length adjusting means 115, allowing shortening and/or elongating first arm 103.

Another sensor 118, such as a potentiometer, may be coupled adjacent joint 113 or pivot 114 within connector 119. Sensor 118 allows to measure the speed rotation or movement of first arm 103. Accordingly, the linear velocity of ball 102 can be measured. Optionally, the measured linear velocity along with the measurement of stroke force and direction of ball 102 provided by sensors 111, allow to calculate the theoretical ballistic route of ball 102.

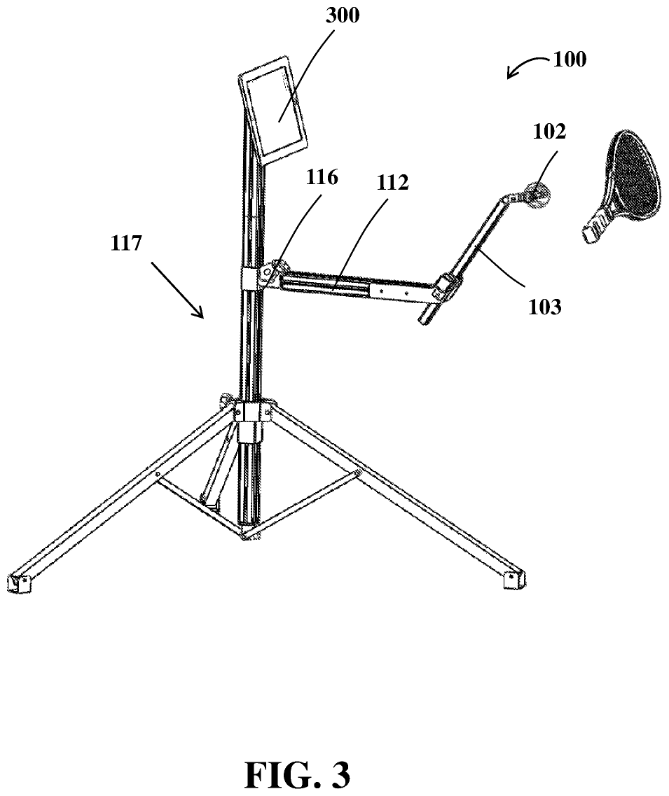

FIG. 3 demonstrates device 100 which may further include binding means 116 for allowing affixing or installing second arm 112 to supporting means, such as tripod 117. Device 100 may be either provided alone without any support means or may be sold as a kit along with supporting means 117. Optionally, the device 100 may be installed to various alternative support means, such as fences etc. As shown herein, tripod 117 includes means allowing hanging a display screen 300 thereto in order to facilitate presentation of the parameters measured by one or more of sensors 110, 111 and 118.

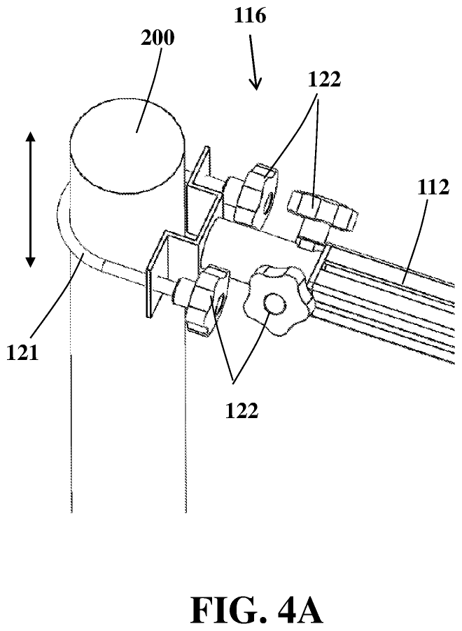

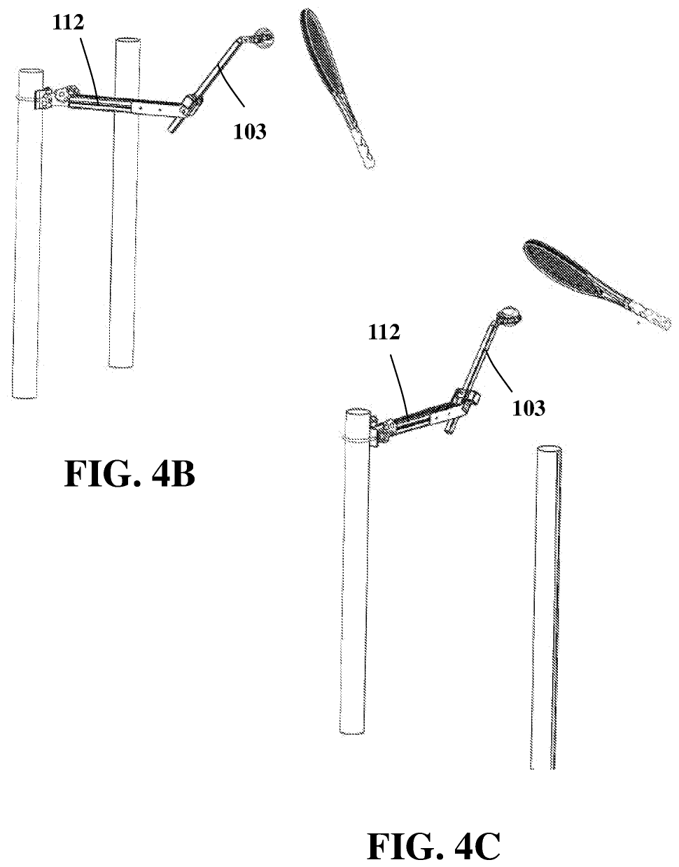

A close-up view, an isometric side view, and an isometric back view of binding means 116 are shows in FIGS. 4A-4C, respectively. As shown in FIG. 4C, binding means 116 allow to affix second arm 112 to a rod 200 which may be part of tripod 117 or of any other structure or element, such as part of a fence. Binding means 116 include a curved bar 121 which can hold rod 200 upon tightening one or more of screws 122. Yet another set of screws 122 may similarly be disposed on biding means 116 and provided to attach second arm 112. Such biding configuration allows 360 degrees rotation of second arm 112 about binding means 116.

As shown in FIGS. 4A and 4B binding means 116 are height adjustable, allowing adjusting of height of device 100 with respect to rod 200. Binding means 116 further allow 360 degrees rotation of second arm 112.

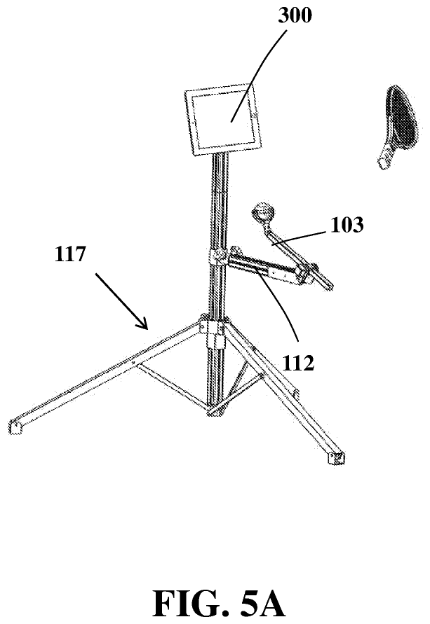

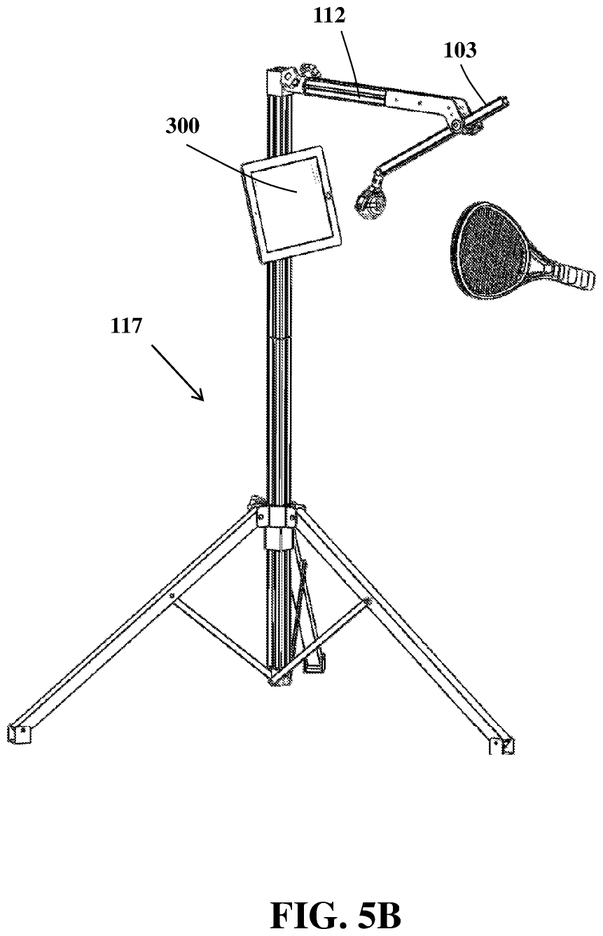

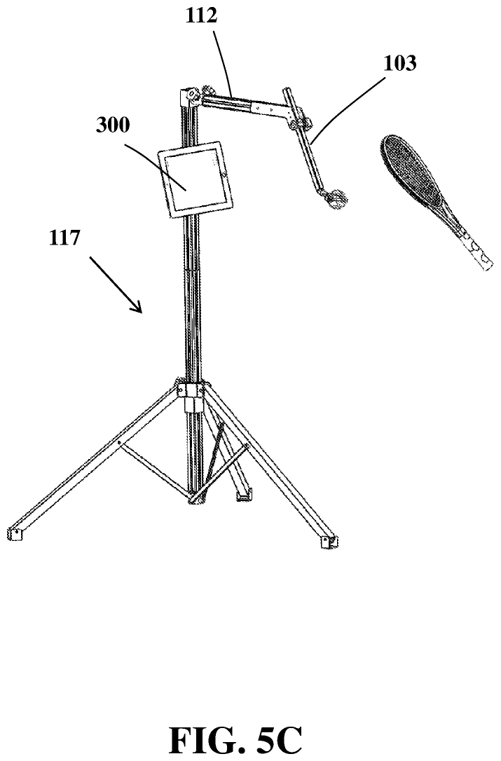

FIGS. 5A-5C demonstrate yet another embodiment of device 100 which is height adjustable. Second arm 112 which can be connected to tripod 117 is height adjustable via binding means 116 which allow lowering (see FIG. 5A) or raising device 100 (see FIGS. 5B and 5C).

Each of the following terms: ‘includes’, ‘including’, ‘has’, ‘having’, ‘comprises’, and ‘comprising’, and, their linguistic, as used herein, means ‘including, but not limited to’, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase ‘consisting essentially of’.

Each of the phrases ‘consisting of’ and ‘consists of’, as used herein, means ‘including and limited to’.

The term ‘method’, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Throughout this disclosure, a numerical value of a parameter, feature, characteristic, object, or dimension, may be stated or described in terms of a numerical range format. Such a numerical range format, as used herein, illustrates implementation of some exemplary embodiments of the invention, and does not inflexibly limit the scope of the exemplary embodiments of the invention. Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably.

The term ‘about’, in some embodiments, refers to ±30% of the stated numerical value. In further embodiments, the term refers to ±20% of the stated numerical value. In yet further embodiments, the term refers to ±10% of the stated numerical value.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub combination in the context or format of a single embodiment, may also be illustratively described and presented in the context or format of a plurality of separate embodiments.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A ball stroke training simulator, comprising:
a ball;
a first arm connected to the ball and configured to allow rotation thereof about a pivot between the first arm and the ball;
a second arm pivotally connected to the first arm such that the first arm is moveable, in response to a ball stroke, about the pivot between the first and second arms; and
at least one sensor adapted to monitor one or more ball stroke parameters.

2. The ball stroke training simulator according to claim 1, further comprising a connector for connecting between the ball and the first arm, the connector attached to the ball via a bearing allowing rotation of the ball around an axis of the ball.

3. The ball stroke training simulator according to claim 2, wherein the connector comprises at least one of an arc and a portion thereof configured to surround at least a portion of the ball, and is at least partially resilient for allowing a slight deformation thereof by a ball stroke.

4-6. (canceled)

7. The ball stroke training simulator according to claim 3, wherein the sensor measures deformation of the resilient portion of the connector, thereby providing at least one of a stroke force and a stroke direction.

8. The ball stroke training simulator according to claim 1, wherein the at least one sensor is affixed to at least one of the ball, the first arm, the second arm, the pivot between the first arm and the second arm, and a combination thereof.

9. The ball stroke training simulator according to claim 1, wherein the sensor measures at least one of: a spin count of the ball per unit of time, a speed of rotation of the ball around an axis of the ball, an angle of a ball stroke, a ball force stroke, a first arm rotation speed, a first arm hit force, a direction of the bearing, a speed of the bearing, and a force at the bearing.

10. The ball stroke training simulator according to claim 1, wherein the ball includes a magnet and the sensor monitors the magnetic pulses of the ball during rotation.

11. The ball stroke training simulator according to claim 1, wherein the first arm being up to 180 degrees rotatable about the pivot between the first arm and the second arm.

12-14. (canceled)

15. The ball stroke training simulator according to claim 1, further comprising a computing device configured to process and analyze the ball stroke parameters and being in at least one of wire and wireless communication with the one or more sensors and adapted to provide an output of the one or more parameters.

16. (canceled)

17. The ball stroke training simulator according to claim 15, further comprising a display module adapted to present the output and the results of the analysis.

18-19. (canceled)

20. The ball stroke training simulator according to claim 15, wherein the ball stroke output includes at least one of: stroke count, spin speed of the ball, ground speed of the ball, angle of a ball stroke, force of the ball stroke, calculate or predict a ball path, calculate or predict point of hit, and a combination thereof.

21-22. (canceled)

23. The ball stroke training simulator according to claim 1, wherein the sensor is selected from at least one of a force sensor adapted to measure a stroke force, a speed sensor adapted to measure a spinning speed of the ball, a touch sensor adapted to measure a stroke angle, an accelerometer, a potentiometer, a gyroscope, a magnetic sensor, a hall-effect sensor, a strain gage, a Global Positioning System (GPS) receiver, and a combination thereof.

24. (canceled)

25. The ball stroke training simulator according to 15, wherein said computing device is configured to present at least one of: a first training schedule or lesson, progress of a trainee, a second training schedule or lesson according to the trainees' capabilities or progress.

26. The ball stroke training simulator according to claim 1, wherein at least one of the first arm, the second arm and the pivot between the arms includes a spring adapted to revert position of the first arm after movement thereof in response to a ball stroke.

27-28. (canceled)

29. A ball stroke training device, comprising:
a ball;
a chassis for supporting the ball and allowing rotation thereof;
one or more sensors for measuring one or more ball stroke parameters, the one or more sensors attached to at least one of the ball and the chassis; and
a computing device being in communication with the one or more sensors and adapted to provide an output of the one or more parameters.

30. The ball stroke training device of claim 29, wherein the chassis comprises:
a first arm connected to the ball such that the ball is rotatable about a pivot between the first arm and the ball; and
a second arm pivotally connected to the first arm such that the first arm is moveable about the pivot between the first and second arms.

31-32. (canceled)

33. The ball stroke training device according to claim 29, further comprising a connector for connecting between the ball and the first arm, the connector attached to the ball via a bearing allowing rotation of the ball around an axis of the ball.

34-35. (canceled)

36. The ball stroke training device according to claim 33, wherein the connector is at least partially resilient allowing at least a slight deformation of the connector by a ball stroke.

37. The ball stroke training device according to claim 29, further comprises at least one sensor affixed to at least one of the ball, the connector, and the bearing.

38-40. (canceled)

41. The ball stroke training device according to claim 29, wherein the ball stroke output includes at least one of: a stroke count, a spin speed of the ball, a ground speed of the ball, an angle of ball stroke, a force of ball stroke, and a combination thereof.

42-46. (canceled)
